(19) United States
(12) Patent Application Publication
(10) Pub. No.: US 2026/0260825 A1
(43) Pub. Date: Sep. 3, 2026

(54) SWITCHING ELEMENT FOR A TEMPERATURE-DEPENDENT SWITCH, TEMPERATURE-DEPENDENT SWITCH, AND METHOD FOR MANUFACTURING THE SWITCHING ELEMENT

(71) Applicant: Marcel P. Hofsaess, Steintahleben (DE)

(72) Inventor: Marcel P. Hofsaess, Steintahleben (DE)

(21) Appl. No.: 19/549,526

(22) Filed: Feb. 25, 2026

(30) Foreign Application Priority Data
Feb. 28, 2025 (DE) 10 2025 107 676.6

(51) Int. Cl. H01H 11/00

(52) U.S. Cl. CPC H01H 11/00

(57) ABSTRACT

A switching element for a temperature-dependent switching mechanism of a temperature-dependent switch. The switching element is configured as a bimetal element or a spring element, has a convexly curved upper side and a concavely curved lower side, and is made of an electrically conductive material, in particular, a metal. The switching element has a plurality of distributed, punctiform elevations for forming local unevenness on the upper side and/or the lower side.

### CROSS-REFERENCE TO RELATED APPLICATIONS

This application claims priority from German patent application DE 10 2025 107 676.6 filed on February 28, 2025. The entire contents of this priority application are incorporated herein by reference.

### FIELD

This disclosure generally relates to a switching element for a temperature-dependent switching mechanism of a temperature-dependent switch. Furthermore, the disclosure generally relates to a temperature-dependent switch, in the temperature-dependent switching mechanism of which the switching element is used. Furthermore, the disclosure generally relates to a method for manufacturing a switching element for a temperature-dependent switching mechanism of a temperature-dependent switch.

A temperature-dependent switch by way of example is disclosed in DE 10 2013 101 392 A1.

Such temperature-dependent switches serve, in a manner known per se, to monitor the temperature of a device. For this purpose, the switch is brought into thermal contact with the device to be protected, for example via one of the outer surfaces of said switch, such that the temperature of the device to be protected influences the temperature of the switching mechanism located inside the switch.

In this case, the switch is typically connected electrically in series with the supply circuit of the device to be protected, via connecting leads, so that below the response temperature of the switch, the supply current of the device to be protected flows through the switch.

The temperature-dependent switching mechanism located inside the switch ensures the temperature-dependent switching behavior of the switch. In the closed switch position, the switching mechanism presses a movable contact part against at least one static mating contact, and thus establishes an electrical connection between the two terminals of the switch. In contrast, in the open switch position the switching mechanism holds the movable contact part at a distance from the at least one static mating contact, so that the electrical connection between the two terminals of the switch is separated.

The switching behavior, i.e., the switching between the closed switch position and the open switch position, takes place in a temperature-dependent manner. The temperature-dependent switching behavior of the switching mechanism is typically achieved by a bimetal element, which, in a known manner, switches or snaps between two configurations – a low-temperature configuration or low-temperature position and a high-temperature configuration or high-temperature position – depending on the temperature, in the manner of a hysteresis.

Thus, if the temperature of the bimetal element increases as a result of a temperature increase in the device to be protected above a defined temperature, which is referred to as the response temperature or switching temperature of the bimetal element, then the bimetal element snaps from its low-temperature configuration into its high-temperature configuration and thus causes a switching operation from the closed switch position to the open switch position or vice versa. In this case, depending on the installation type, the switch can be configured such that below the response or switching temperature it is in the closed switch position, which is referred to as “normally closed,” or instead in the open switch position, which is typically referred to as “normally open.”

In most of these temperature-dependent switches, a spring element is also used in the temperature-dependent switching mechanism, in addition to the bimetal element. This spring element is typically referred to as a “temperature-independent spring element,” because its behavior is independent of temperature, unlike the behavior of the bimetal element.

If such a spring element is used in the temperature-dependent switching mechanism, it typically serves to relieve the bimetal element, specifically both mechanically and electrically. In the closed switch position, it typically exerts the contact pressure by which the movable contact part is pressed against the at least one stationary mating contact. Furthermore, it carries the electric current in the closed switch position. In the case of the use of such a spring element, the bimetal element can thus be mounted without mechanical force in the closed switch position and, moreover, does not have to serve as a current-carrying component. This has a tremendously positive effect on the lifespan of the bimetal element.

The bimetal elements and spring elements used in the temperature-dependent switching mechanisms of such temperature-dependent switches are generally referred to in the present case as “switching element(s),” within the meaning of the present disclosure.

These switching elements, i.e., both the bimetal elements and the spring elements, are usually very small, fragile components only a few millimeters in size, which are stored and transported as bulk goods after their manufacture. In this type of bulk goods storage, electrostatic adhesions may occur due to friction, which adhesions can have a negative impact during the assembly process.

Due to such adhesions, it is necessary that the individual switching elements must be separated from each other in a time-consuming manner before being inserted into the switch housing. If the switching elements overlap precisely, it may even be the case that two such switching elements are accidentally inserted into the switch, instead of just one, and this only becomes apparent later, i.e., after the switch has been assembled, due to malfunctions. Even fitters, with their well-trained eyes, make this type of mistake from time to time, resulting in time-consuming and costly follow-up checks for safety reasons.

Furthermore, the relevant switching elements usually undergo a hardening process before assembly. This hardening process is typically carried out in a furnace under protective gas. Overlapping and adhesion of the individual switching elements can therefore lead to irregular or insufficient hardening results. For example, traces of oxygen may remain in the system or on the surfaces of the switching elements. This is particularly critical if the surfaces of the switching elements are coated with an additional metal layer, e.g., a silver layer, to improve conductivity.

Therefore, it is essential to spread the switching elements to be hardened in several levels in the hardening furnace, and usually to ensure manually that they do not overlap or adhere to one another. Otherwise, the protective gas cannot reach every switching element from all sides. The separation process required for this is also time-consuming and furthermore reduces furnace capacity. Furthermore, a higher consumption of protective gas is necessary, which in turn is costly.

In the case of fully automated feeding of the switching elements, the overlapping, as well as the precise adhesion of the switching elements, presents a problem insofar as separation by means of vibrating pot feeding or magazining only inadequately solves the problem. Therefore, similar problems to those already explained above also arise for the manual assembly of the switching elements. As a result, time-consuming and therefore costly follow-up checks are necessary here as well, which is why fully automated assembly of the switching elements has mostly proven to be uneconomical so far, and why a large number of manual assembly processes still have to be used when assembling such temperature-dependent switches.

### SUMMARY

It is an object to provide a switching element and a method for manufacturing the switching element which can overcome or at least largely eliminate the aforementioned disadvantages. In this case, one object is in particular to prevent the adhesion or overlapping of the switching elements, described above, during bulk goods storage and/or during a hardening process, and, furthermore in particular to prevent two adhering switching elements from being mistakenly inserted into one switch during assembly of the switch.

According to a first aspect, a switching element for a temperature-dependent switching mechanism of a temperature-dependent switch is presented, the switching element being configured as a bimetal element or spring element, having a convexly curved upper side and a concavely curved lower side, and being made of an electrically conductive material, in particular metal, the switching element comprising a plurality of distributed, punctiform elevations for forming local unevenness on the upper side and/or the lower side.

According to a second aspect, a method for manufacturing a switching element for a temperature-dependent switching mechanism of a temperature-dependent switch is presented, which comprises the following steps:
(i) punching out the switching element from a metal sheet;
(ii) forming the switching element to bring the switching element into a curved shape with a convexly curved upper side and a concavely curved lower side; and
(iii) creating a plurality of distributed, punctiform elevations in the switching element to form local unevenness on the upper side and/or the lower side.

The switching element is thus provided with a plurality of punctiform elevations, which lead to local unevenness on the convexly curved upper side and/or the concavely curved lower side of the switching element. This creates local unevenness in the otherwise smooth surfaces. This largely prevents a plurality of such switching elements, stored as bulk goods, from adhering to one another.

The elevations also act as spacers, so that smaller gaps are created between the switching elements when said elements are stacked on top of each other. During the hardening process, the protective gas used can thus reach almost all parts of the switching elements much more uniformly, with the result that better hardening results can be achieved.

Although the elevations mean that the volume increases slightly when storing bulk goods, the individual switching elements can be separated from each other much more easily during assembly. This also significantly simplifies the fully automated separation of the switching elements provided as bulk goods. This can virtually eliminate the possibility of accidentally inserting two switching elements instead of one switching element into the switch, whether manually or fully automatically.

The punctiform elevations with which the switching element is provided can alternatively also be described as punctiform bumps, studs, protrusions or spacer elements.

The punctiform or point-like design of these elevations is advantageous insofar as, in contrast to elongate struts or larger extended regions, results in no or, if at all, only negligible, changes in the characteristic behavior, in particular the dynamic behavior, of the switching element.

In particular, local stiffening of the switching element should be avoided, in order not to negatively influence the switching behavior of the switching element. However, the applicant’s experiments have shown that punctiform elevations have no or at least a barely measurable influence on the switching behavior of the switching element. Although lesser material stiffening cannot be completely avoided due to the punctiform elevations, a resulting increase in the actuating force of the switching element can be compensated for by using thinner material with a higher modulus of elasticity.

The switching element is preferably a punched part.

It is also preferred if steps (ii) and (iii) of the method, i.e., the steps of reshaping the switching element into its curved shape and of creating the punctiform elevations, are carried out together in one work step (i.e., simultaneously or in combination) by stamping the switching element.

The insertion of the punctiform elevations therefore requires no extra work step. Therefore, the production costs will not increase or, if at all, only very slightly. Furthermore, the punctiform elevations can be reliably produced by stamping.

According to a refinement, the switching element is preferably made of a bimetal, a trimetal, steel or copper-beryllium.

If the switching element is a bimetal element, it comprises a bimetal or trimetal. This is usually a multi-layered, thin metal sheet consisting of at least two different layers of different metals or metal alloys, which differ in particular in their coefficients of thermal expansion. These different coefficients of thermal expansion of the interconnected metal layers lead to the corresponding temperature-dependent snapping behavior, which causes the aforementioned change in shape when the switching or response temperature is reached.

If, in contrast, the switching element is a spring element, then it is preferably made of steel or copper-beryllium. In this case, the spring element is preferably configured as a snap disk or as a balancing spring.

According to a further refinement, the switching element is designed substantially in the shape of a circular disk in plan view.

In the case of such a circular disk-shaped embodiment of the switching element, the punctiform elevations prove to be particularly advantageous, since in a circular disk-shaped design, adhesions between a plurality of switching elements can occur particularly frequently, leading to complete overlaps of said elements, which are hardly visible to the naked eye.

However, the switching element does not necessarily have to be designed in the shape of a circular disk. The switching element is typically adapted to the shape of the switch housing and can, for example, be oval or substantially rectangular. If the switching element is a spring element, this can, for example, also be configured as a three-legged or four-legged spring. The punctiform elevations are also advantageous in this case, since they act as spacer elements during the hardening process, keeping the individual switching elements, positioned above one another, at a distance from each other, and also facilitate the separation of the individual switching elements.

According to a further refinement, the switching element has a hole in its center.

The movable contact part of the switching mechanism is preferably passed through this hole. When the switch is installed, depending on the design, the switching element, with its central hole, can be loosely placed over the movable contact part, attached thereto captively but with play, or fixedly connected to the movable contact part.

According to a further refinement, the punctiform elevations are arranged off-center and spaced apart from an outer edge of the switching element.

It has been shown that the aforementioned advantageous effects of simplified separation and the improved spacing can be enhanced by an off-center arrangement of the elevations. Conversely, the punctiform elevations should also not, however, be arranged at the very outermost edge of the switching element, as this is not only difficult to ensure from a manufacturing perspective, but rather can also have a negative impact on the switching behavior and the electrical contacting of the switching element.

According to a further refinement, the punctiform elevations are arranged so as to be distributed symmetrically with respect to the center of the switching element. Preferably, the punctiform elevations are arranged point-symmetrically with respect to the center of the switching element.

This has the advantage, in particular, that any negative influences on the switching behavior that may arise are distributed evenly or symmetrically. Substantially, however, this has the advantage that the punctiform elevations ensure a uniform contact side for other switching elements that lie above them during bulk goods storage. Furthermore, this intentionally leaves a degree of freedom (rotation about the central axis of the switching element) during assembly.

According to a further refinement, the punctiform elevations are molded into the switching element. Thus, in other words, the punctiform elevations are formed integrally with the switching element. Alternatively, in still other words, the punctiform elevations are preferably formed integrally with the remaining parts of the switching element.

This simplifies the manufacture of the punctiform elevations and also has advantages in terms of stability. Removing them is impossible.

According to a further refinement, the punctiform elevations are each formed by a stamped indentation, which has a corresponding punctiform depression on the side opposite the relevant elevation.

Such stamped indentations are relatively easy to produce and are preferably made in the switching element in the same work step in which the switching element is brought into its convex-concave shape. In this case, the stamped indentations are made in the switching element either from below, i.e., from the lower side, so that they form a punctiform depression on the lower side of the switching element and a punctiform elevation on the upper side of the switching element. Likewise, the stamped indentations can also be made in the switching element from above, i.e., from the upper side thereof, so that they form a punctiform depression on the upper side of the switching element and a punctiform elevation on the lower side of the switching element.

In this case, it is particularly preferred for the stamped indentations made in the switching element to either all be made in the switching element from below or all made in the switching element from above. In principle, however, a mixed insertion (at least one stamped indentation made from below and at least one stamped indentation made from above) would also be possible.

According to a further refinement, the material thickness of the switching element in the region of the punctiform elevations is less than in the other regions of the switching element. In other words, the switching element is thinner in the region of the punctiform elevations than in the remaining regions. “Material thickness” therefore refers to the thickness of the metal sheet from which the switching element is typically made.

This refinement in particular has the advantage that the punctiform elevations result in extremely low stiffening of the switching element. Therefore, the punctiform elevations have no undesirable influence on the switching behavior of the switching element. In the case of the switching element being configured as a bimetal element, the resulting stiffening even has the advantage that it leads to a kind of pre-stamping, which in turn causes the bimetal element to “migrate” less (hysteresis) before the switching process, meaning that it requires less installation space.

A thinner material thickness in the region of the punctiform elevations results automatically when these are molded into the switching element by stamping, as mentioned above. Therefore, a stamped indentation design is also advantageous for this reason.

According to a further refinement, the switching element has two, three, four, five or six of the punctiform elevations.

According to a further refinement, a height and a diameter measured transversely thereto, of at least one (preferably all) of the punctiform elevations are in each case less than 1 mm, preferably less than 0.5 mm, particularly preferably less than 0.3 mm.

Such a size is already sufficient to produce the aforementioned advantageous properties. Conversely, the smaller the punctiform elevations are, the less influence they have on the switching behavior of the switching element or harbor the risk of unwanted collisions with other components of the temperature-dependent switching mechanism.

The punctiform elevations are preferably approximately round (round points) when seen in plan view.

As mentioned at the outset, the present disclosure relates not only to the switching element itself, but also to a temperature-dependent switch in which the switching element is used.

Such a temperature-dependent switch has two terminals and a temperature-dependent switching mechanism which is configured, depending on its temperature, to switch between a closed switch position, in which an electrically conductive connection is established between the two terminals, and an open switch position, in which the electrically conductive connection is interrupted, the temperature-dependent switching mechanism comprising a switching element.

According to a further refinement of the temperature-dependent switch, the switching mechanism comprises a static contact and a movable contact part, the switching element being operatively connected to the movable contact part in such a way that it presses the movable contact part against the static contact in the closed switch position and/or keeps it spaced apart from the static contact in the open switch position.

The movable contact part can, for example, be arranged in a hole provided centrally in the switching element or be passed through said hole. The punctiform elevations are arranged around the movable contact part without having direct contact with the movable contact part or other switching mechanism components.

Of course, the features mentioned above and those still to be explained below can be used not only in the combination specified in each case but also in other combinations or on their own without departing from the spirit and scope of the present disclosure.

### BRIEF DESCRIPTION OF THE DRAWINGS

FIG. 1 is a plan view from above of a first embodiment of a switching element;

FIG. 2 is a plan view from above of a second embodiment of the switching element;

FIG. 3A is a sectional view of the switching element shown in FIG. 1 according to the first embodiment, and FIG. 3B is a detailed view of this sectional view;

FIG. 4A is a sectional view of the switching element shown in FIG. 2 according to the second embodiment, and FIG. 4B is a detailed view of this sectional view;

FIGS. 5A-5C are each plan views, from above, of three further embodiments of the switching element;

FIG. 6 is a schematic sectional view of an embodiment of a switch, the switch being in the closed switch position;

FIG. 7 is a schematic sectional view of the switch shown in FIG. 6, the switch being in the open switch position;

FIG. 8 is a schematic illustration of a first work step in the manufacture of the switching element; and

FIG. 9 is a schematic illustration of a second work step in the manufacture of the switching element.

### DESCRIPTION OF PREFERRED EMBODIMENTS

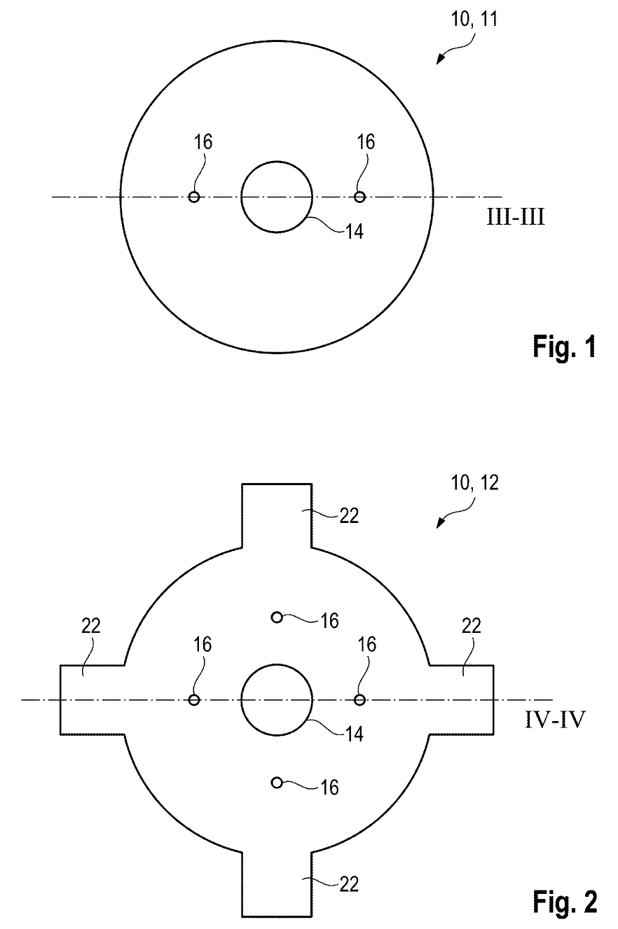

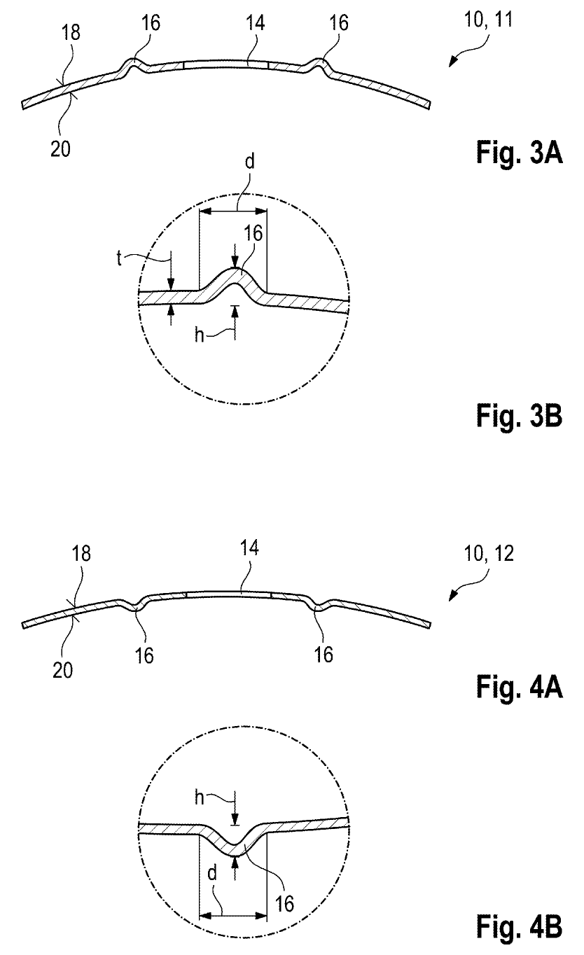

FIGS. 1, 3A and 3B show a first embodiment of the switching element. Therein, the switching element is denoted in its entirety by reference sign 10. FIG. 1 shows the switching element 10 in a plan view from above. FIG. 3A shows the switching element 10 in a sectional view. FIG. 3B shows an enlarged detail from FIG. 3A.

The switching element 10 is, for example, a bimetal element 11, which is configured as a circular disk-shaped bimetallic disk. The bimetal element 11 has a hole 14 in the center. Furthermore, the bimetal element 11 has two punctiform elevations 16 which are arranged off-center, preferably at the same distance from the central hole 14. Therefore, an overall symmetrical arrangement of the switching element 10 preferably results.

As can be seen in particular from FIG. 3A, the bimetal element 11 is convex-concavely curved. The bimetal element 11 has a convexly curved upper side 18 and a concavely curved lower side 20, which is opposite the upper side 18.

Apart from the punctiform elevations 16, the switching element 10 is preferably curved in an arc shape on both its upper side 18 and its lower side 20 and preferably has a constant curvature.

The punctiform elevations 16 are a type of bump or stud that are molded into the switching element 10. The punctiform elevations 16 are preferably stamped into the switching element 10. In the embodiment shown here, these are therefore stamped indentations.

The punctiform elevations 16, designed as stamped indentations, are preferably of a comparatively small design. The height h and the diameter d are preferably a few tenths. The height h as well as the diameter d of the elevations 16 is preferably < 0.5 mm, particularly preferably < 0.3 mm.

According to the first embodiment shown in FIG. 1 and 3A, the stamped indentations are designed such that the punctiform elevations 16 result on the convex upper side 18. The punctiform elevations 16 thus form local elevations on the convex upper side 18, while they form local depressions on the concave lower side.

As can be seen in particular from FIG. 3B, the material thickness t of the switching element 10 is less in the region of the punctiform elevations 16 than in the remaining parts of the switching element 10. This is in particular due to the fact that the elevations 16 are molded into the switching element 10, and thus local expansion points occur in the region of the elevations, at which points the material thickness is locally reduced. However, this in turn has the advantage that the elevations 16 lead to no, or at least no measurable, stiffening of the switching element 10.

FIGS. 2, 4A and 4B show a second embodiment of the switching element 10. The switching element 10 is configured therein as a spring element 12. The spring element 12 is preferably made of steel or of copper-beryllium.

In principle, the spring element 12 can have a similar or even the same shape as the bimetal element 11, i.e., be designed in the shape of a circular disk. In the embodiment shown here, however, the spring element 12 is only designed in a circular disk shape in its inner region. In the outer region, it has four radially projecting portions 22, such that the spring element 12, as a whole, forms a kind of four-legged spring. Of course, the spring element 12 can also be configured as a three-legged spring, i.e., have three radially projecting portions 12, with which the spring element 12 rests on the edge.

Viewed in cross section, the spring element 12 is curved in an arc shape, similar to the bimetal element 11 shown in FIGS. 1 and 3A. It therefore has a convex-concave cross-sectional shape with a convexly curved upper side 18 and a concavely curved, opposite lower side 20.

The spring element 12 has four elevations 16 according to the embodiment shown in FIGS. 2 and 4A. However, of course, similarly to the bimetal element 11, two, three or more than four punctiform elevations 16 may also be provided.

In the embodiment shown in FIGS. 2 and 4A, the elevations 16 are oriented toward the lower side 20. They thus form local elevations on the concavely curved lower side 20 of the switching element 10, while they form local depressions on the opposite upper side 18 of the switching element 10.

Although in the two embodiments shown here the punctiform elevations 16 are oriented toward the upper side 18 in the case of the switching element 10 configured as a bimetal element 11, and toward the lower side 20 in the case of the switching element 10 configured as a spring element 12, this can of course also be the other way around. It is also possible that, in the same switching element 10, one or more punctiform elevations 16 is/are oriented toward the upper side 18 and one or more punctiform elevations 16 is/are oriented toward the lower side 20.

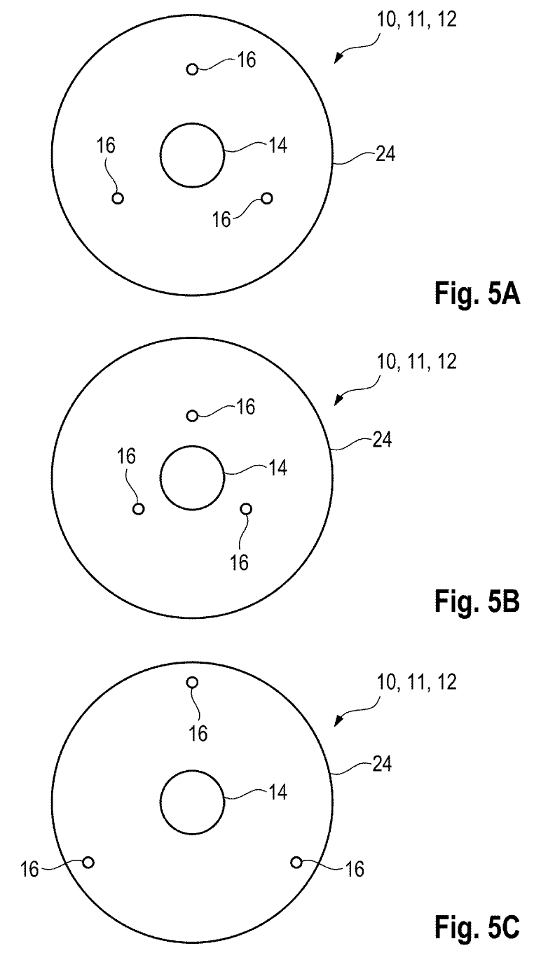

FIGS. 5A-5C further show three additional embodiments which are intended to illustrate different conceivable arrangements of the elevations 16. Therein, the switching element 10 is again designed to be circular disk-shaped, with a centrally placed hole 14. The switching element 10 can be a bimetal element 11 or a spring element 12.

In the first embodiment shown in FIG. 5A, the punctiform elevations are each approximately the same distance from the central hole 14 as from an outer edge 24 of the switching element 10.

In the embodiment shown in FIG. 5B, the punctiform elevations 16 are located at a smaller distance from the central hole 14 than from the outer edge 24. Thus, in other words, they are positioned closer to the central hole 14 than to the outer edge 24 of the switching element 10.

In the embodiment shown in FIG. 5C, the punctiform elevations 16 are, in contrast, arranged closer to the outer edge 24 than to the central hole 14. Thus, in other words, the distance between the punctiform elevations 16 and the outer edge 24 of the switching element 10 is smaller than the distance between the punctiform elevations 16 and the central hole 14.

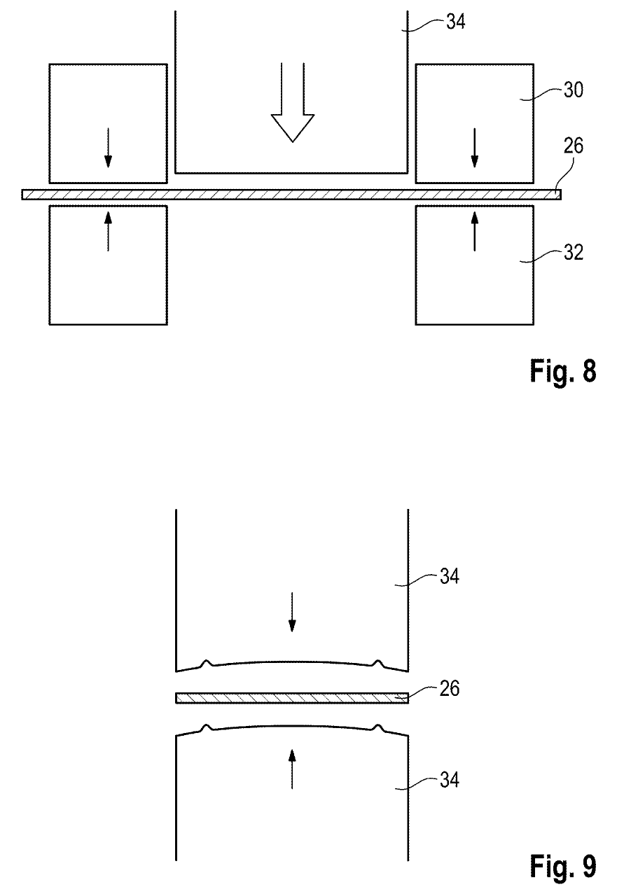

FIGS. 8 and 9 show, in schematic form, two processing steps during the manufacturing method of the switching element 10.

In the first processing step shown in FIG. 8, a blank 28 is punched out of a metal sheet 26. In this case, the metal sheet 26 is fixed over a die 32 using a hold-down device 30, while a punching die punches the blank 28 out of the metal sheet 26.

In the second work step, indicated schematically in FIG. 9, the blank 28 is brought into its ultimately desired shape using a two-part stamping die. In this case, preferably not only is the arc-shaped curvature, i.e., the convex-concave cross-sectional shape of the switching element 10, created, but rather the punctiform elevations 16 are also molded into the switching element 10 at the same time. For this purpose, the two-part stamping die 34 has a corresponding stamping shape in order to stamp the switching element 10 together with the punctiform elevations 16 into the desired shape in one work step.

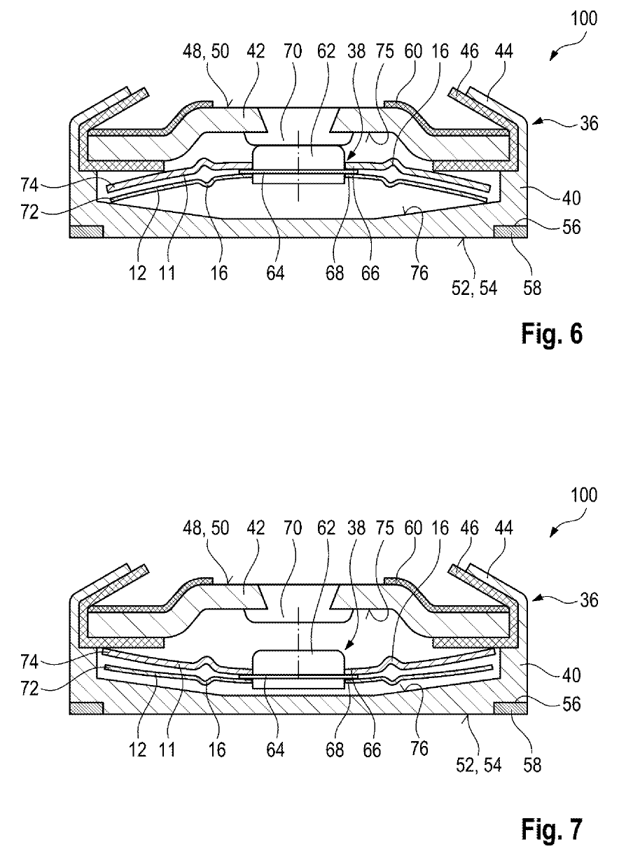

FIGS. 6 and 7 show a possible embodiment of a temperature-dependent switch 100 in which the switching element 10 is used. In the embodiment of the switch 100 shown here, not only is the bimetal element 11, as shown in FIGS. 1 and 3A, used, but rather also the spring element 12, as shown in FIGS. 2 and 4A.

FIG. 6 shows the closed switch position of the switch 100. FIG. 7 shows the open switch position of the switch 100.

Of course, the switch 100 shown in FIGS. 6 and 7 is only one example of various possible temperature-dependent switches in which the switching element 10 can be used. The switching element 10 can in principle also be used in various other temperature-dependent switches that are constructed differently from the switch 100 shown in FIGS. 6 and 7. However, the switch 100 shown in FIGS. 6 and 7 is described below by way of example as a possible temperature-dependent switch, in order to explain the basic structure and the function of such a temperature-dependent switch.

The switch 100 has a switch housing 36, inside which a temperature-dependent switching mechanism 38 is arranged. The switch housing 36 comprises a pot-shaped lower part 40 and a cover part 42, which is held on the lower part 40 by a bent or crimped upper edge 44.

In the embodiment of the switch 100 shown in FIGS. 6 and 7, both the lower part 40 and the cover part 42 are made of an electrically conductive material, preferably metal. An insulating film 46 is arranged between the lower part 40 and the cover part 42. The insulating film 46 ensures electrical insulation of the lower part 40 from the cover part 42. Likewise, the insulating film 46 ensures a mechanical seal that prevents liquids or impurities from entering the interior of the switch housing 36 from the outside.

Since in this example the lower part 40 and the cover part 42 are each made of electrically conductive material, thermal contact can be established with a device to be protected, via their outer surfaces. The outer surfaces simultaneously also serve as the electrical terminal for the switch 100. For example, the outer surface 48 of the cover part 42 can function as the first electrical terminal 50 and the outer side 52 of the lower part 40 can function as the second terminal 54. For example, a peripheral groove 56 can be provided on the outer side 52 of the switch lower part 40, into which groove a corresponding connecting ring 58 is inserted.

A further insulating layer 60 is arranged on the outside of the cover part 42.

The switching mechanism 38 is arranged clamped between the lower part 40 and the cover part 42. The switching mechanism 38 has a movable contact part 62 in addition to the bimetal element 11 and the spring element 12. The movable contact part 62 is guided through the hole 14 provided centrally in the bimetal element 11, as well as through the hole 14 provided centrally in the spring element 12. A peripheral, circular disk-shaped collar 64, which is arranged approximately centrally on the movable contact part 62, separates the bimetal element 11 from the spring element 12. The bimetal element 11 rests with its inner edge 66 against the collar 64 of the movable contact part 62. The spring element 12 rests with its inner edge 68 against the collar 64 of the movable contact part 62 from below.

In the closed switch position of the switch 100 shown in FIG. 6, the spring element 12 presses the movable contact part 62 from below against the stationary mating contact 70 arranged on the cover part 42. This stationary mating contact 70 is also frequently referred to as the “static contact” 70 of the switch 100. In this case, the spring element 12 rests with its outer edge 72 on the inner base 76 of the lower part 40.

In this switch position of the switch 100, the bimetal element 11 preferably rests freely with its inner edge 66 on the collar 64 of the movable contact part 62, from above. The outer, peripheral edge 74 of the bimetal element 11 hangs freely into the inside of the housing 36. The bimetal element 11 is thus mounted in the switch housing 36, in the closed switch position of the switch 100, with virtually no force, without being firmly clamped therein.

In the closed switch position of the switch 100 shown in FIG. 6, the temperature-dependent switching mechanism 38 establishes an electrically conductive connection between the two terminals 50, 54 of the switch 100 in that the movable contact part 62 is pressed against the stationary mating contact 70 arranged on the cover part 42. The contact pressure with which the movable contact part 62 is pressed against the stationary contact part 70 in the closed switch position of the switch 100 is caused by the spring element 12 in the switch 100.

If the temperature of the device to be protected, and thus the temperature of the switch 100 and the bimetal element 11 arranged therein, now increases to or above the switching or response temperature of the bimetal element 11, then the bimetal element 11 snaps from its convex low-temperature configuration shown in FIG. 6 to its concave high-temperature configuration shown in FIG. 7. During this snapping process, the bimetal element 11 rests with its outer edge 74 against the lower side 75 of the cover part 42 and presses the movable contact part 62 downward with its inner edge 66. This lifts the movable contact part 62 away from the stationary contact part 70. As a result, the spring element 12 simultaneously bends downward at its center, so that the spring element 12 snaps from its first geometric configuration shown in FIG. 6 into its second geometric configuration shown in FIG. 7. The electrical connection, previously established via the switching mechanism 38, between the two terminals 50, 54 of the switch 100 is thus interrupted.

The temperature-dependent switching mechanism 38 of the switch 100 is thus configured to establish and disconnect the electrically conductive connection between the two terminals 50, 54, depending on the temperature.

Depending on the desired embodiment, the temperature-dependent switching mechanism 38 can either be configured as previously explained, namely that below the switching temperature of the bimetal element 11 the switching mechanism 38 assumes the closed switch position shown in FIG. 6 and above the switching temperature assumes the open switch position shown in FIG. 7, or vice versa. In the first case, reference is made to a switch with the “normally closed” configuration. In the second case, reference is made to a switch with the “normally open” configuration.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A switching element for a temperature-dependent switching mechanism of a temperature-dependent switch, the switching element being a bimetal element or a spring element, having a convexly curved upper side and a concavely curved lower side, and being made of an electrically conductive material,
wherein the switching element comprises a plurality of distributed, punctiform elevations for forming local unevenness on at least one of the upper side or the lower side.

2. The switching element according to claim 1, wherein the switching element is made of a bimetal, a trimetal, steel or copper-beryllium.

3. The switching element according to claim 1, wherein the switching element has an annular shape or disk shape in plan view.

4. The switching element according to claim 1, wherein the switching element has a hole in a center of the switching element.

5. The switching element according to claim 1, wherein the punctiform elevations are arranged off-center and are spaced apart from an outer edge of the switching element.

6. The switching element according to claim 1, wherein the punctiform elevations are arranged so as to be evenly spaced from one another.

7. The switching element according to claim 1, wherein the punctiform elevations are arranged so as to be distributed symmetrically with respect to a central axis of the switching element.

8. The switching element according to claim 1, wherein the punctiform elevations are molded into the switching element.

9. The switching element according to claim 1, wherein the punctiform elevations are each formed by a stamped indentation which has a corresponding punctiform depression on a side opposite the respective punctiform elevation.

10. The switching element according to claim 1, wherein, in a region where no punctiform elevations are formed on the switching element, a first material thickness of the switching element is larger than a second material thickness of the punctiform elevations measured in parallel to the first material thickness.

11. The switching element according to claim 1, wherein the switching element comprises two, three, four, five or six of the punctiform elevations.

12. The switching element according to claim 1, wherein each of a height and a diameter, measured transversely to the height, of at least one of the punctiform elevations is less than 1 mm.

13. The switching element according to claim 1, wherein each of a height and a diameter, measured transversely to the height, of at least one of the punctiform elevations is less than 0.3 mm.

14. A temperature-dependent switch having two terminals and a temperature-dependent switching mechanism which is configured, depending on its temperature, to switch between a closed switch position, in which an electrically conductive connection is established between the two terminals, and an open switch position, in which the electrically conductive connection is interrupted, wherein the temperature-dependent switching mechanism comprises a switching element, the switching element being a bimetal element or a spring element, having a convexly curved upper side and a concavely curved lower side, and being made of an electrically conductive material, wherein the switching element comprises a plurality of distributed, punctiform elevations for forming local unevenness on at least one of the upper side or the lower side.

15. The temperature-dependent switch according to claim 14, wherein the temperature-dependent switching mechanism comprises a static contact and a movable contact part, wherein the switching element is operatively connected to the movable contact part in such a way that it presses the movable contact part against the static contact in the closed switch position and/or keeps it spaced apart from the static contact in the open switch position.

16. A method for manufacturing a switching element for a temperature-dependent switching mechanism of a temperature-dependent switch, comprising the steps of:
(i) punching out the switching element from a metal sheet;
(ii) forming the switching element into a curved shape with a convexly curved upper side and a concavely curved lower side; and
(iii) creating a plurality of distributed, punctiform elevations in the switching element to form local unevenness on the upper side and/or the lower side.

17. The method according to claim 16, wherein steps (ii) and (iii) are carried out jointly by stamping the switching element.
